(19) United States
(12) Patent Application Publication
(10) Pub. No.: US 2004/0251353 A1
(43) Pub. Date: Dec. 16, 2004

(54) Laboratory apparatus for grinding loose materials

(76) Inventor: Giorgio Berselli, Montagnana Di Serramazzoni (IT)

Correspondence Address: Modiano & Associati, Via Meravigil 16, Milano, 20123, IT

(21) Appl. No.: 10/494,302

(22) PCT Filed: Nov. 8, 2002
(86) PCT No.: PCT/EP02/12525

(30) Foreign Application Priority Data
Nov. 13, 2001 (IT) MO2001A000218

(51) Int. Cl. B02C 17/14

(52) U.S. Cl. 241/175

(57) ABSTRACT

A laboratory apparatus for grinding loose materials, comprising a frame for supporting a shaft that is mounted for rotation about its own axis and is associated with a corresponding motor actuation and with supports for supporting a container that has at least one opening for introducing and withdrawing the materials and is arranged eccentrically with respect to the shaft; the container is adapted to assume at least one active configuration, in which it traces an orbit around the shaft, which is rotationally actuated, and at least one inactive configuration for introducing the materials to be ground and/or for withdrawing the ground materials.

The present invention relates to a laboratory apparatus for grinding loose materials.

### BACKGROUND OF THE INVENTION

Laboratories for the testing, research, control and development of several types of new or existing products, such as raw materials, enamels, screen printing pastes, mixes, dyes and the like, are known in the ceramics field.

The preparation of test samples generally entails a step for grinding and homogenizing the loose materials that compose the product to be tested.

Known types of laboratory apparatus for grinding loose materials are substantially constituted by a cabinet provided with an opening and closure door, which contains one or more rotation devices, each suitable to cause the rotation of a respective jar about a vertical axis.

Each jar comprises a container, provided with a mouth for introducing and withdrawing the materials, a plug for closing the mouth, and a charge of grinding media, constituted by beads.

These laboratory apparatuses, however, are not devoid of drawbacks, including the fact that the structure of the cabinets and the manual handling of the jars limit the dimensions and the capacity of the jars that can be used; this accordingly prevents the production of homogeneous test samples in quantities greater than those obtainable from a single jar.

It is noted that if it is necessary to prepare a test sample in quantities exceeding the actual capacity of a single jar, one grinds separately, by using a plurality of jars, quantities that are submultiples of the required quantity, each having the same composition and formulation as the sample.

Because of the possible human, instrument and environmental errors that are associated with any laboratory test, the compositions of the prepared submultiple quantities can be different one another, with their own grinding charges, with the risk of biasing the results of the tests being performed.

Another drawback of known apparatuses is that they require awkward and repeated manual operations for carrying, mounting and removing the jars from the cabinets, with consequent waste of time, human resources and costs.

In fact, technicians prepare each jar with the material to be ground, mount it and fix it inside the cabinet and, at the end of the grinding process, release it and remove it from the cabinet in order to withdraw the ground material therefrom.

### SUMMARY OF THE INVENTION

The aim of the present invention is to eliminate the above noted drawbacks of conventional apparatus by providing a laboratory apparatus for grinding loose materials that allows to prepare homogeneous test samples, does not require the execution of mounting and removal operations at each grinding cycle, and allows to improve the use of human resources and time utilization.

Within this aim, an object of the present invention is to provide a structure that is simple, relatively easy to provide in practice, safe in use, effective in operation, and relatively low in cost.

This aim and this and other objects that will become better apparent hereinafter are achieved by the present laboratory apparatus for grinding loose materials, characterized in that it comprises a frame for supporting a shaft that is mounted for rotation about its own rotation axis and is connected to corresponding motor means and with supporting means for supporting a container that has at least one mouth for introducing and withdrawing the materials and is arranged eccentrically with respect to said shaft, the container being provided so as to assume at least one active configuration, in which it traces an orbit around the shaft, which is rotationally actuated, and at least one inactive configuration for introducing the materials to be ground and/or for withdrawing the ground materials.

### BRIEF DESCRIPTION OF THE DRAWINGS

Further characteristics and advantages of the present invention will become better apparent from the detailed description of a preferred but not exclusive embodiment of a laboratory apparatus for grinding loose materials, illustrated only by way of non-limitative example in the accompanying drawings, wherein:

FIG. 1 is a schematic axonometric view of an apparatus according to the invention;

FIG. 2 is a schematic side view of FIG. 1;

FIG. 3 is a schematic front view of FIG. 1;

FIG. 4 is a schematic enlarged-scale view of a detail of the apparatus according to the invention;

FIG. 5 is a schematic sectional view of FIG. 4.

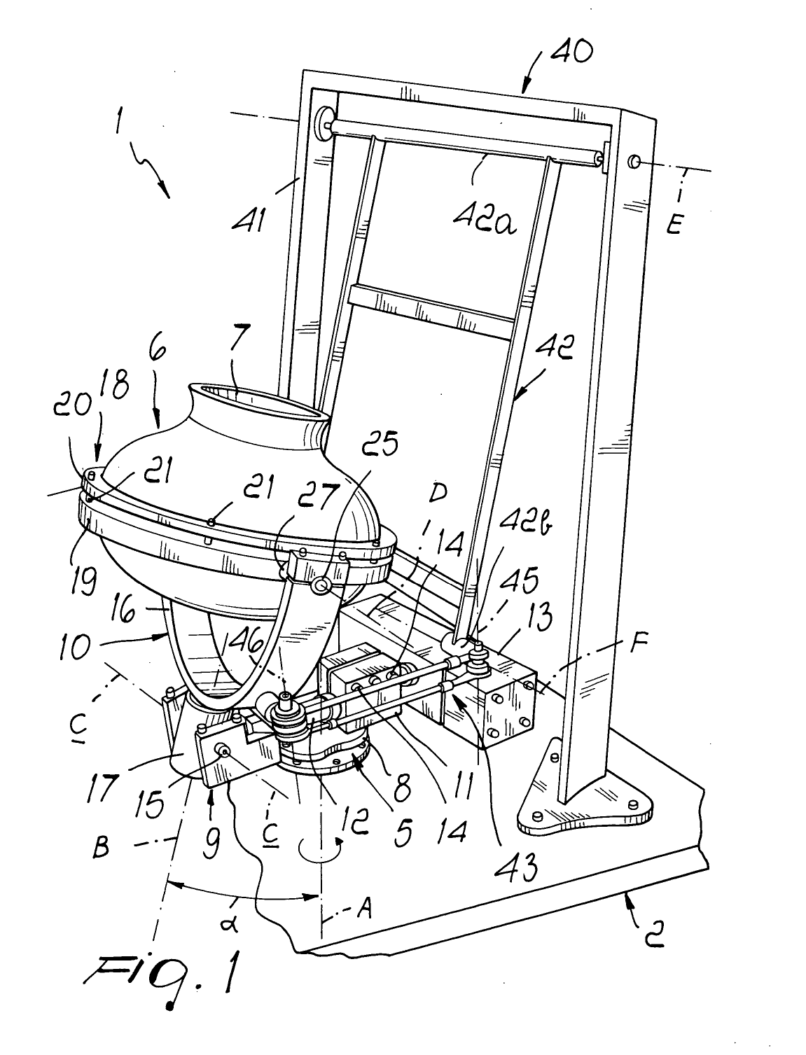

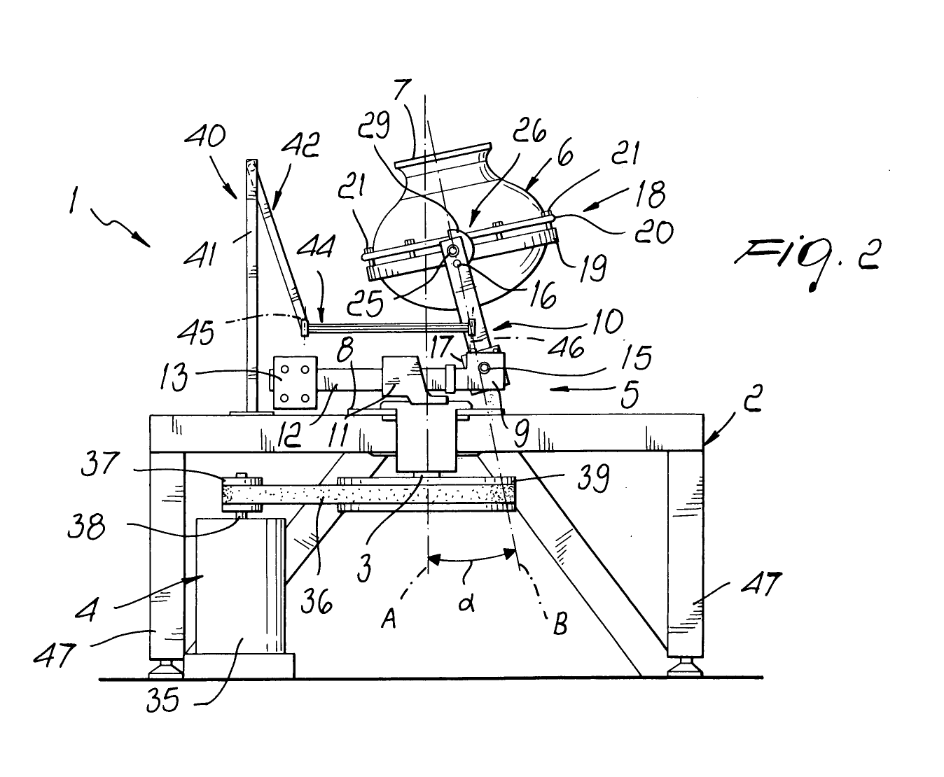

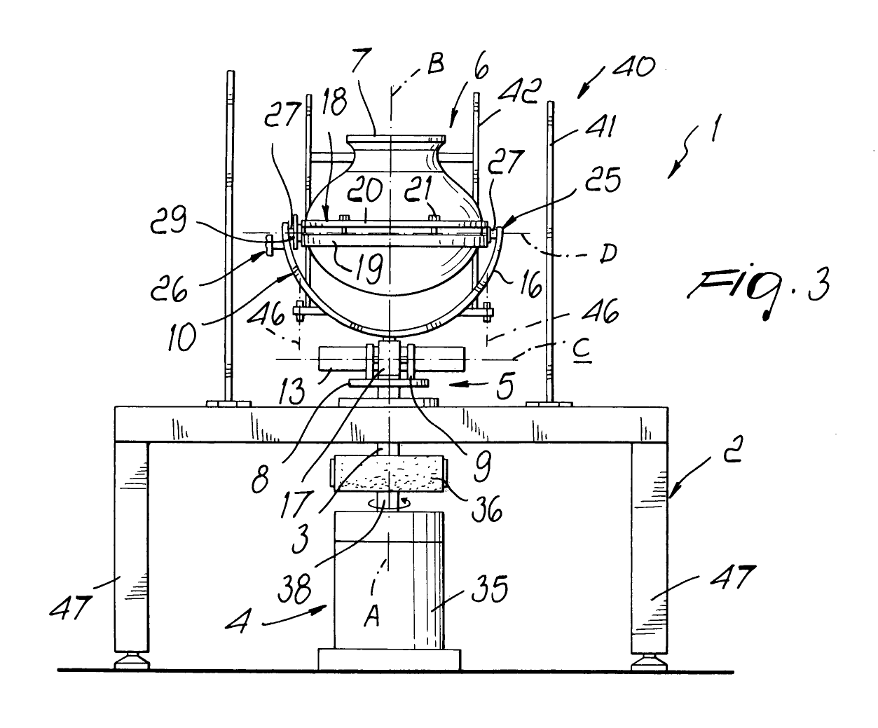

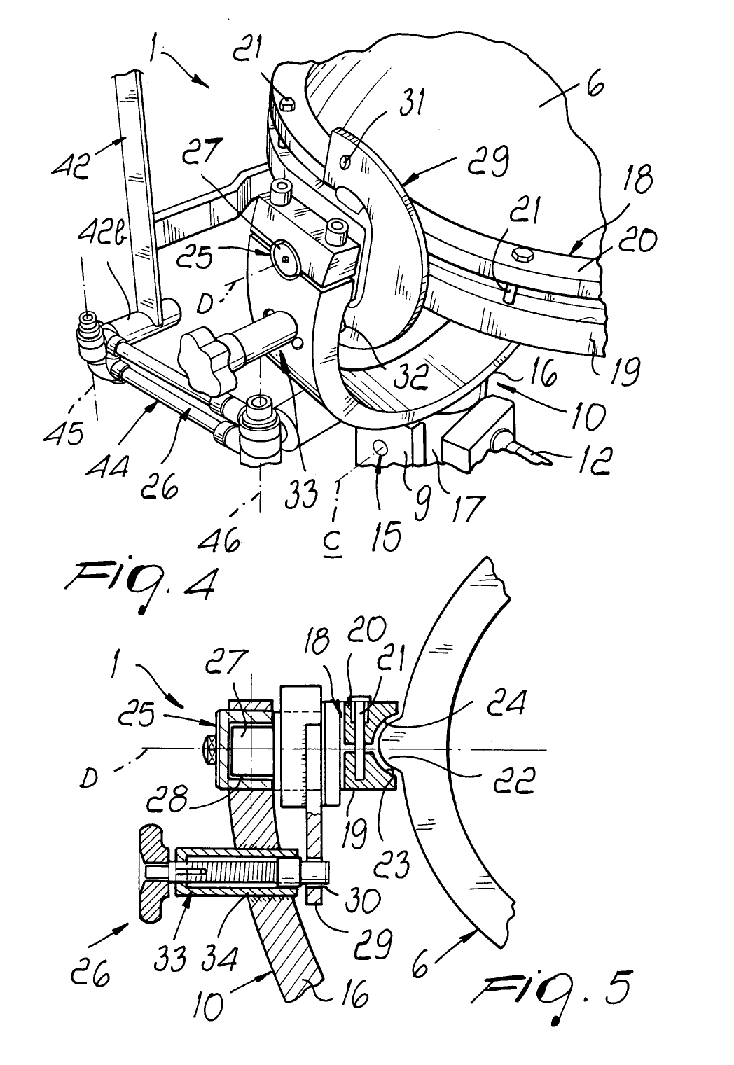

### DESCRIPTION OF THE PREFERRED EMBODIMENTS

With reference to the figures, the reference numeral 1 generally designates a laboratory apparatus for grinding loose materials.

The apparatus 1 comprises a supporting frame 2, with which a shaft 3 rotatable about its own axis A is associated; motor means 4, which are suitable to turn the shaft 3; and supporting means 5, associated for joint movement with the shaft 3, for supporting a grinding container 6.

The container 6 is constituted by a globular body that is substantially symmetrical with respect to a longitudinal axis B and tapers into a neck in which there is an opening 7 for introducing the materials to be ground and for withdrawing the ground materials.

The container 6, moreover, is provided with a closure plug and with a screening grate that is associated with the opening 7; in a possible embodiment, the grate can be formed monolithically with the plug.

The container 6 is arranged so that its axis B lies in an eccentric position with respect to the axis A of the shaft 3.

In the active configuration, the shaft 3 is rotationally actuated by the motor means 4 and the container 6 traces a circular orbit around the axis A for grinding the materials introduced therein; in the inactive configuration, the shaft 3 is motionless and allows to introduce the materials to be ground in the container 6 or to withdraw the ground materials therefrom.

The supporting means 5 are constituted by a plate-like base 8, coupled for joint motion to one end of the shaft 3, by a support 9, which is associated with the base 8, and by a framework 10 that supports the container 6.

Means for adjusting the eccentricity of the container 6 are interposed between the base 8 and the support 9 and are constituted by a clamp-like support 11, which is coupled to the base 8, and by an arm 12, which lies transversely to the shaft 3 and is inserted slidingly between the jaws of the support 11, its two ends supporting respectively the support 9 and a counterweight 13.

The sliding of the arm 12 with respect to the support 11 allows to adjust the eccentricity or distance of the axis B of the container 6 with respect to the axis A of the shaft 2; the arm 12 is locked by way of fixing or locking means constituted by screws 14 for tightening the two jaws of the support 11.

The framework 10 is articulated, so that it can oscillate about a first axis C that is not parallel, but contained in a plane perpendicular to the axis A of the shaft 3, to the support 9 by way of first articulation means, constituted by a first cylindrical hinge 15.

The hinge 15 allows to incline the framework 10 and therefore the axis B of the container 6 with respect to the axis A of the shaft 3.

In the active configuration, the axis B of the container 6 is inclined with respect to the axis A of the shaft 3 by an angle α of 0 to 45 sexagesimal degrees.

Advantageously, the breadth of the angle α is substantially equal to 20 sexagesimal degrees.

The framework 10 is constituted by a C-shaped bracket 16 in which the concave side is orientated so as to wrap around the container 6 and the convex side has a shank 17 that is articulated to the support 9 by means of the first hinge 15.

The apparatus 1 further comprises means 18 for anchoring the container 6 to the supporting means 5.

The anchoring means 18 are of the clamp type and comprise: a first jaw, constituted by a first ring 19 that is associable with the framework 10; a second jaw, which is constituted by a second ring 20 that is detachably associable with the first one; and means for coupling and uncoupling the second ring 20 with respect to the first ring 19, which are constituted by a plurality of screws 21.

The container 6 is provided with grip protrusions that are constituted by an annular ridge 22 that is shaped in relief on its outer lateral surface and can be inserted and secured within the two rings 19 and 20.

Along the grip faces of the rings 19 and 20 there are respective seats 23 and 24 for supporting and clamping the ridge 22; conveniently, the ridge 22 is formed proximate to the equatorial line of the body of the container 6.

The container 6 is articulated to the framework 10 so that it oscillates about a second axis D, which is not parallel, but contained in a plane perpendicular to the axis A of the shaft 3, by way of second articulation means, which are constituted by a second cylindrical hinge 25.

Second means 26 for locking the oscillation of the container 6 with respect to the framework 10 are provided.

In the inactive configuration, the second hinge 25 allows to position the container 6 so that the opening 7 is directed upward in order to introduce the materials to be ground or so that the opening 7 is directed downward in order to withdraw the ground materials.

The second hinge 25 is constituted by two opposite pivots 27, whose respective ends are rigidly coupled to the outer edge of the first ring 19 and whose opposite ends are inserted rotatably in corresponding seats 28 formed in the framework 10.

The second locking means 26 are constituted by a plate 29, which is rigidly associated with the first ring or jaw 19.

The plate 29 has three reference holes 30, 31 and 32, which form respectively the active configuration and the two inactive configurations for withdrawing and introducing the materials in the container 6.

A locking pin 33, accommodated in a through hole 34 of the framework 10, can be inserted in one of the holes 30, 31 and 32 in order to block the oscillation of the container 6 about the axis D.

Advantageously, the axes C and D are substantially parallel one another and transverse to the axis A of the shaft 3.

The motor means 4 are constituted by a motor 35 and by transmission means such as a belt 36 wound in a loop around a driving pulley 37, which is rigidly coupled to the driving shaft 38, and a driven pulley 39.

The apparatus 1 further comprises a structure 40 for supporting the framework 10 that allows to balance said framework 10 and guide it in its rotary motion.

The structure 40 is constituted by a portal 41, which is fixed to the frame 2 and to which the end 42a of a swinging bracket 42 is articulated so that it oscillates about an axis E; the opposite end 42b of said bracket is articulated, so as to oscillate about an axis F, to a sort of articulated parallelogram.

The parallelogram is formed by two pairs of linkages 43 and 44, which are parallel and are articulated to the end 42b about first pivots 45 and to the framework 10 about second pivots 46.

The apparatus 1 further comprises means for damping the vibrations generated in the active configuration; said means are constituted for example by shock-absorbing means associated with the ground supporting feet 47 of the frame 2.

It is noted that the counterweight 13 also has a vibration-damping function.

In practice it has been found that the described invention achieves the intended aim and objects.

Finally, the apparatus according to the invention can be inserted and used in an actual production system.

The invention thus conceived is susceptible of numerous modifications and variations, all of which are within the scope of the appended claims.

All the details may further be replaced with other technically equivalent ones.

In practice, the materials used, as well as the shapes and the dimensions, may be any according to requirements without thereby abandoning the scope of the appended claims.

The disclosures in Italian Patent Application No. MO2001A000218 from which this application claims priority are incorporated herein by reference.

What is claimed is:

1. to 29. (cancelled).

30. A laboratory apparatus for grinding loose materials, comprising a frame for supporting a shaft that is mounted for rotation about a rotation axis thereof and is connected to corresponding motor means and with supporting means for supporting a container that has at least one opening for introducing and withdrawing the materials and is arranged eccentrically with respect to said shaft, the container being provided so as to assume at least one active configuration, in which it traces an orbit around the shaft, which is rotationally actuated, and at least one inactive configuration for introducing the materials to be ground and/or for withdrawing the ground materials.

31. The apparatus of claim 30, wherein said supporting means comprise first means for the articulation of said container about a first axis, which are adapted to incline the container with respect to said shaft, and first means for locking said container.

32. The apparatus of claim 30, wherein in the active configuration said container is inclined with respect to said shaft by an angle of 0 to 45 sexagesimal degrees.

33. The apparatus of claim 30, wherein in the active configuration said container is inclined with respect to said shaft by an angle of substantially 20 sexagesimal degrees.

34. The apparatus of claim 30, wherein said supporting means comprise means for adjusting eccentricity of said container with respect to said shaft.

35. The apparatus of claim 34, wherein said supporting means comprise a base that is rigidly coupled to said shaft, a support that is associated with said base, and a framework that supports said container and is associated with said support.

36. The apparatus of claim 31, wherein said first articulation means are formed between said framework and said support.

37. The apparatus of claim 31, wherein said first articulation means comprise at least one first cylindrical hinge.

38. The apparatus of claim 35, wherein said eccentricity adjustment means are formed between said support and said base.

39. The apparatus of claim 35, wherein said eccentricity adjustment means comprise an arm that lies transversely to said shaft, is slidingly associated with said base and supports said support, means for fixing said arm with respect to said base being provided.

40. The apparatus of claim 35, wherein said supporting means comprise second means for articulation about a second axis and second means for locking said container, said second articulation means being adapted to incline the container in at least one inactive configuration for introducing the materials to be ground and/or in at least one inactive configuration for withdrawing the ground materials.

41. The apparatus of claim 40, wherein said second articulation means are formed between said container and said supporting framework.

42. The apparatus of claim 40, wherein said second articulation means comprise at least one second cylindrical hinge.

43. The apparatus of claim 40, wherein said first and second axes are parallel one another and transverse with respect to said shaft.

44. The apparatus of claim 40, wherein said second locking means comprise at least one plate, which is rigidly associated with said container and which comprises at least two reference holes of said inactive configurations, respectively for introducing and withdrawing the materials, and at least one locking pin that is associated with said supporting framework and can be inserted in said holes.

45. The apparatus of claim 40, further comprising means for anchoring said container to said supporting framework.

46. The apparatus of claim 45, wherein said anchoring means comprise a first jaw that is associable with said framework, a second jaw that is detachably associable with the first jaw, and means for rigidly coupling said second jaw to said first jaw, the container being provided with grip protrusions, which are formed on outer lateral surface thereof and are adapted to be clamped between said jaws.

47. The apparatus of claim 45, wherein said second locking means are formed between said anchoring means and said supporting framework.

48. The apparatus of claim 45, wherein said second articulation means are formed between said anchoring means and said supporting framework.

49. The apparatus of claim 44, wherein said plate is rigidly associated with said first jaw.

50. The apparatus of claim 30, wherein said container is constituted by a globular body that tapers into a neck in which said opening is formed, said body having a ridge that is shaped in relief on its outer lateral surface and is suitable to form said protrusions.

51. The apparatus of claim 50, wherein said ridge is formed proximate to the equatorial line of said globular body.

52. The apparatus of claim 30, wherein said container comprises a plug for closing said opening.

53. The apparatus of claim 30, wherein said container comprises a screening grate that is associated with said opening.

54. The apparatus of claim 46, wherein said first jaw and said second jaw are constituted respectively by two rings in which said container can be inserted at least partially and along which seats for supporting and clamping said protrusions are formed.

55. The apparatus of claim 30, comprising a supporting structure for said supporting framework, which is articulated to said frame and to said framework.

56. The apparatus of claim 55, wherein said supporting structure comprises a portal that is fixed to said frame and a bracket in which one end is articulated to said portal and the opposite end is articulated to said supporting framework.

57. The apparatus of claim 30, further comprising means for absorbing the vibrations generated in said active configuration.

58. The apparatus of claim 57, wherein said absorption means comprise ground resting feet of said frame that have respective shock-absorbing means.
